(19) United States
(12) Patent Application Publication
(10) Pub. No.: US 2016/0207262 A1
(43) Pub. Date: Jul. 21, 2016

(54) ELECTRONICALLY ENABLED EFFECT FOR A PRINTED OBJECT

(71) Applicant: Disney Enterprises, Inc., Burbank, CA (US)

(72) Inventor: Robert Scott Trowbridge, La Canada, CA (US)

(21) Appl. No.: 14/598,189

(22) Filed: Jan. 15, 2015

(51) Int. Cl. B29C 67/00; G05B 15/02

(52) U.S. Cl. CPC B29C 67/0088; G05B 15/02; B33Y 50/02

(57) ABSTRACT

A process integrates object geometry data of an object and data describing an electronic component that is embeddable within the object to generate a printable model. The process also prints an object based upon the integrated printable model. A computing apparatus, e.g., a computing device, a printer, etc., uses a processor to perform the integration and at least one printer head to print the object. The process partially prints the object and then retrieves the electronic component specified by the integrated 3D printable model. The process then operably connects the electronic component to the partially complete object and subsequently completes printing the object. The process can print mechanical receivers for the electronic component or install prefabricated mechanical receivers.

### BACKGROUND

1. Field

This disclosure generally relates to the field of 3D printing. More particularly, the disclosure relates to 3D printing.

2. General Background

The field of 3D printing has allowed for the fabrication of physical goods such as toys, figurines, etc. with the use of a 3D printer. A computing device, e.g., a personal computer (“PC”), laptop, etc. typically obtains a 3D model of the object. The computing device then provides that 3D model to a 3D printer to reproduce the physical goods from the 3D model.

3D printers use various techniques to apply raw material(s) onto a substrate at specific locations determined by an X-Y movement mechanism that moves the substrate and/or the print heads, thereby building structures one layer at a time. Example deposition techniques include fused deposition (akin to polymer extrusion), selective laser sintering, direct metal laser sintering, selective laser melting and the like. 3D printing systems, however, seem to be implemented as complete stand-alone alternatives to conventional manufacturing processes. As a result, 3D printing is used for relatively simple objects that do not include pre-made electronic, optical, audio devices and the like. In some cases a 3D printer may be used to make a part for a larger construction, in which cases the part is taken out of the 3D printer and placed into a conventional product assembly line. These applications forego many of the advantages of a 3D printer, particularly for making consumer goods at the point of consumption since the requirement of a conventional assembly line is inconsistent with producing the goods at the point of consumption.

A process for providing electronic enablement data to print an object is needed.

### SUMMARY

A process integrates object geometry data of an object and data describing an electronic component that is embeddable within the object to generate a printable model. The process also prints an object based upon the integrated printable model. A computing apparatus, e.g., a computing device, a printer, etc., uses a processor to perform the integration and at least one printer head to print the object.

The process partially prints the object and then retrieves the electronic component specified by the integrated 3D printable model. The process then operably connects the electronic component to the partially complete object and subsequently completes printing the object. The process can print mechanical receivers for the electronic component or install prefabricated mechanical receivers.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a 3D printing configuration.

FIG. 2 illustrates a 3D printing configuration that receives an integrated 3D printable model from a server.

FIG. 3 illustrates an example of the internal components of the 3D printer.

FIG. 4 illustrates an example of the object that is printed with an integrated electronic component.

### DETAILED DESCRIPTION

A 3D printing configuration is provided to print objects that are capable of providing an electronically enabled effect, e.g., an audio playback, a haptic effect, a lighting feature, an IR communication, etc. The 3D printing configuration obtains object geometry data, data that describes placement of an electronic component within the object to be printed, and/or programming data that is used to program the electronic component to provide the electronic effect. Examples of the programming data include data for audio phrases, lighting features, etc. In one implementation, the electronic component is prefabricated and is positioned within the printed object by a capable 3D printer. In another implementation, the 3D printer prepares an appropriate installation configuration and signals a user to manually place the component. In yet another implementation, the electronic component is fabricated in real time by the 3D printer and then positioned within the printed object.

As an example, the 3D printing configuration is used to print a toy. In addition to printing physical features of the toy, the 3D printing configuration also embeds a prefabricated circuitry component in the toy. The prefabricated circuitry component has circuitry for storage, access, playback, and processing of an audio file.

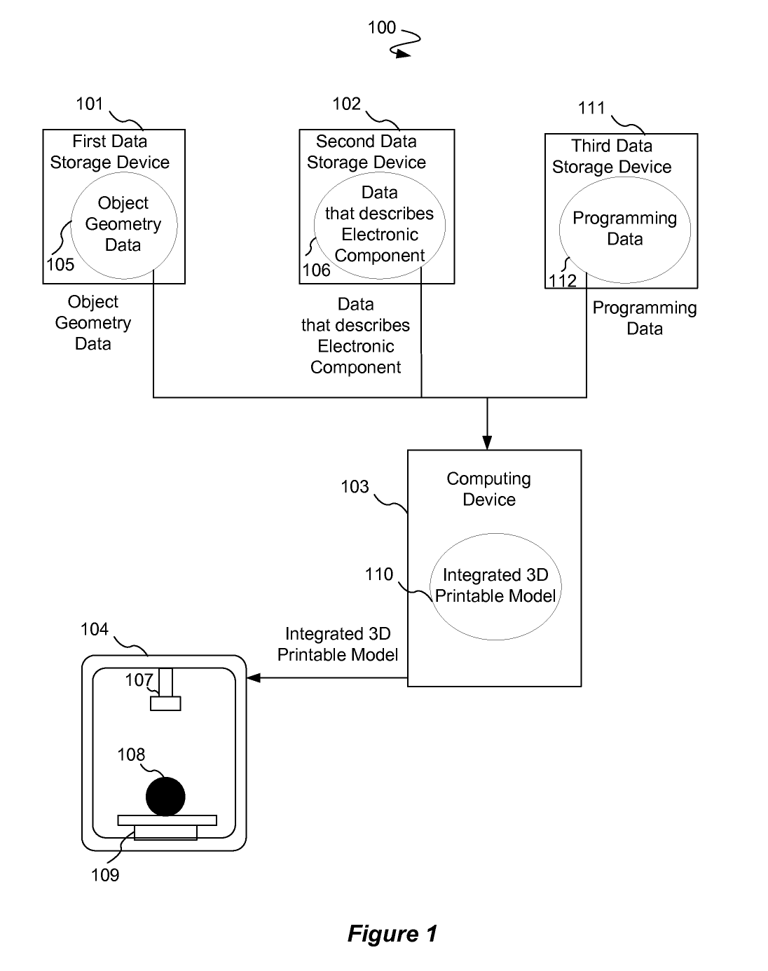

FIG. 1 illustrates a 3D printing configuration 100. The 3D printing configuration 100 includes a first data storage device 101, a second data storage device 102, a third data storage device 111, a computing device 103, and a 3D printer 104.

In one implementation, the first data storage device 101 stores object geometry data 105 for an object, e.g., a toy, a figurine, etc. The object geometry data includes details for the shape, dimensions, etc. of the passive object. The second data storage device 102 stores data 106 that describes an electronic component. For example, the data 106 can provide the identity of an electronic component, e.g., model number, manufacturer name, etc., the type of the electronic component, e.g., audio module, video module, haptic effect module, lighting module, sensor module, etc., and/or the location for placement of the electronic component within the 3D object. The third data storage device 111 stores programming data 112 that is used to program the electronic component to provide an electronic effect. The electronic component is a component that is a playback device, e.g., a video or audio playback device, without preprogramming of a specific audio or video file. The electronic component is a generic component that can be used in multiple passive objects, but differently based upon the particular programming data for a passive object. The programming data 112 can be included in an audio file or a video file. As an example, the programming data 112 is data for a particular phrase that is included in an audio file.

The data storage devices 101, 102, and 111 are in operable communication with the computing device 103 to provide the corresponding data to the computing device 103. The data storage devices 101, 102, and 111 may be devices that interact locally with the computing device 103, e.g., USB devices, memory devices, etc., or devices that are stored on remote computing devices, e.g., servers, that interact remotely with the computing device 103. In another implementation, a single data storage device is used to store object geometry data 105, data 106, and programming data 112. In yet another implementation, a user can directly input the data 105, 106, and 112 at the computing device 103.

After receiving the data 105, 106, and 112, the computing device 103, e.g., a personal computer (“PC”), laptop computer, tablet device, smartphone, etc., integrates the data 105, 106, and 112 into an integrated 3D printable model 110. For instance, the computing device 103 uses the object geometry data 105 and the data 106 to determine an acceptable position in the 3D model of the 3D object in which the electronic component can be positioned for proper functionality. As an example, the computing device 103 uses the data 105 and 106 to determine that the upper back area of the 3D model of the object has enough space for the electronic component and is sufficiently close to an audio speaker that will be positioned in the head of the 3D model of the object. Therefore, the computing device 103 calculates geometric coordinates in the 3D model of the 3D model of the object based on the determined position of the electronic component.

The computing device 103 sends the integrated 3D printable model 110 to the 3D printer 104 after integrating the data 105, 106, and 112 into the integrated 3D printable model 110. The computing device 103 sends instructions to the 3D printer 104 to print the 3D printable object. The 3D printer 104 has a turntable 109 on which a multi-material spool or other material is placed. The 3D printer 104 uses a printer head 107 to print the 3D object. The 3D printer 104 may use a single printer head 107 or multiple printer heads 107.

In another implementation, data 105, 106, 112, and any additional data are preintegrated prior to being received by the computing device 103. As an example, a user or a computing device may preintegrate data 105, 106, and 112, and any other data into a single data file. That single data file is then sent to the computing device 103. The computing device 103 then sends the preintegrated 3D printable model to the 3D printer 104 with an instruction to print an object based upon the preintegrated 3D printable model.

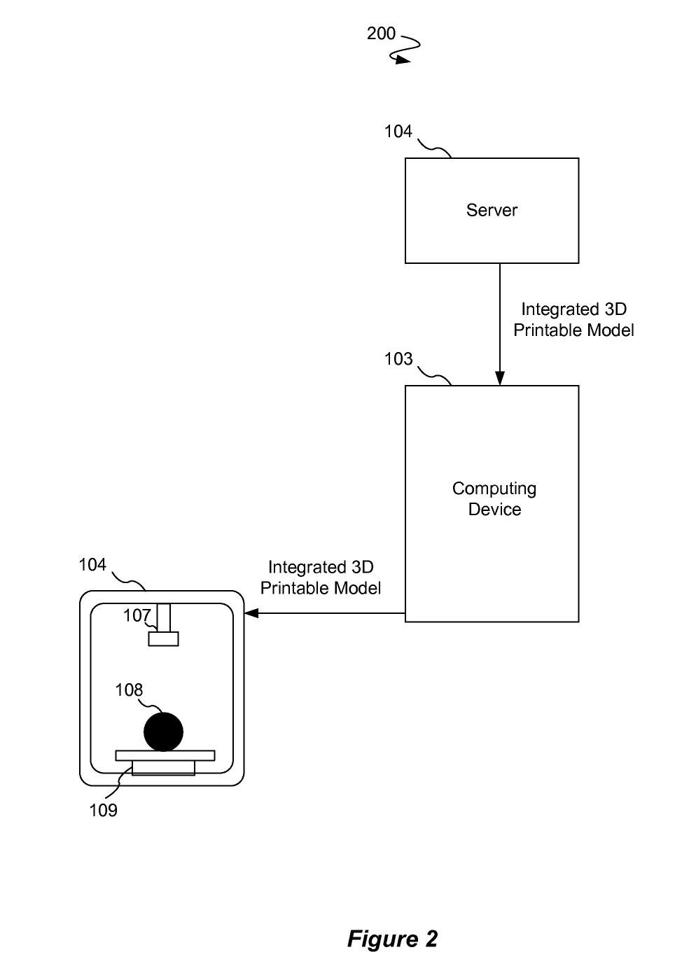

In another implementation, the computing device 103 receives data 105, 106, and 112 from a remote device. FIG. 2 illustrates a 3D printing configuration 200 that receives an integrated 3D printable model from a server 104. The server 104 performs the integration of data 105, 106, and 112. The server 104 then sends the integrated 3D printable model to the computing device 103 such that the computing device 103 can send the integrated 3D printable model to the 3D printer 104 with instructions to print an object based upon the integrated 3D printable model. The server 104 can instead send the data 105, 106, and 112 to the computing device 103 without preintegration such that the computing device 103 performs the integration.

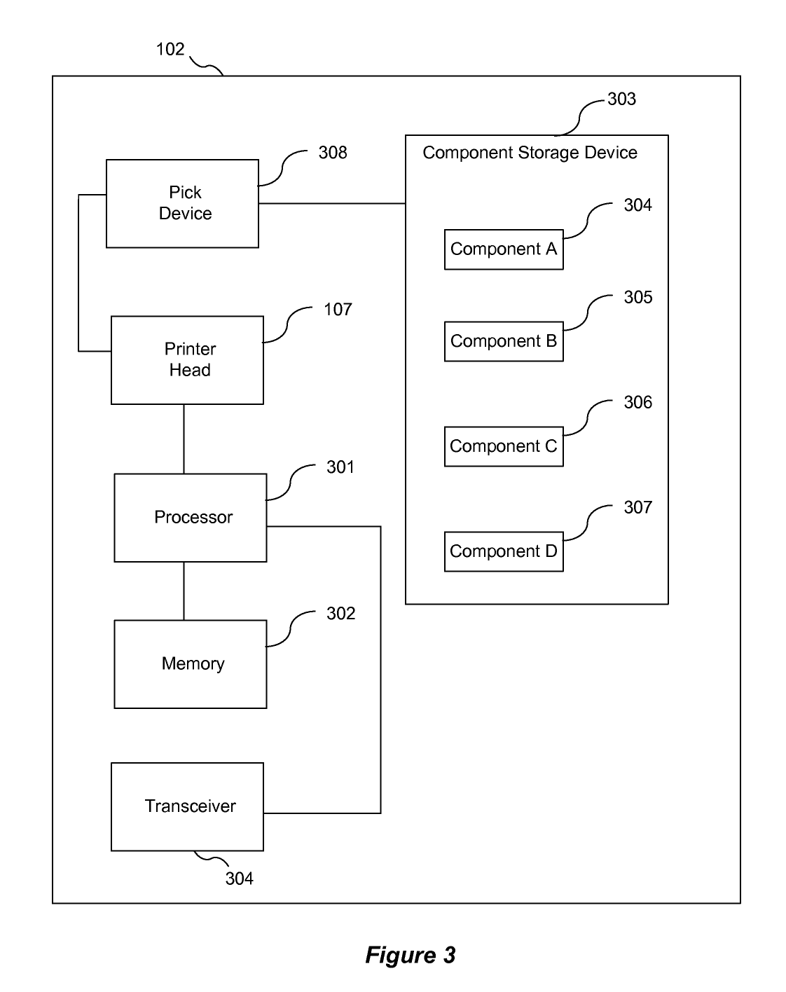

FIG. 3 illustrates an example of the internal components of the 3D printer 102. The 3D printer comprises a processor 301 that provides instructions to the printer head 107 to print the object 108 illustrated in FIG. 1. The processor 301 receives the instructions from the computing device 103 illustrated in FIGS. 1 and 2. Further, the processor 301 stores the instructions in a memory 302. The instructions include a component identifier, e.g., a component name, a component model number, etc., that is used to select an electronic component from a component storage device 303, e.g., a tray, bin, etc. In one implementation, the processor 301 provides instructions to the 3D printer 102 to initiate the printing process of the object 108 based upon the integrated 3D printable model. The processor 301 instructs the 3D printer 102 to only partially print the object 108 until the electronic component has to be installed within the object 108. The processor 301 then provides the component identifier to a pick device 308, e.g., a robotic arm, to select a corresponding electronic component, e.g., component A 304, component B 305, component C 306, or component D 307, from the component storage device 303. The pick device 308 then positions the selected component within the object 108 and operably attaches the electronic component to the object 108. For instance, the pick device 308 can attach the electronic component to mechanical receivers within the object 108. The mechanical receivers may be printed by the 3D printer 102 during the printing process or may be prefabricated. Prior to or after installation of the electronic component within the object 108, the computer device 103 or the 3D printer 102 can send the programming data 112 and any accompanying code to the electronic component, e.g., through a wired or wireless connection. For instance, the processor 301 can instruct the pick device 308 to move the electronic component to a USB port of the 3D printer for a data transfer of the programming data 112 and any accompanying code. After the data transfer, the processor 301 instructs the pick device 308 to install the electronic component into the object 108. The processor 301 then provides instructions to the 3D printer 102 to resume printing of the remaining portions of the object 108.

As an example, the object 108 is a toy that has an audio electronic component that plays an audio file. Prior to completion of the 3D printing process, the 3D printer 102 positions the audio electronic component within the toy at a position in which the toy has enough space to accommodate the audio electronic component and that is in enough proximity to a speaker device integrated within the toy to play the audio file. The 3D printer 102 then resumes 3D printing of the remaining portions of the object 108. As a result, the object 108 has an integrated electronic component that may or may not be accessible from the exterior of the toy after completion of the 3D printing process.

The components 304, 305, 306, and 307 can each correspond to a different electronic effect, e.g., an audio electronic component for audio playback, a video electronic component for video playback, etc. A component 304, 305, 306, or 307 can also contain multiple parts such that the component 304, 305, 306, or 307 is self contained. For example, a component 304 can be an electronic component with its own storage, processor, and audio speaker that is able to be integrated into the object 108 during the 3D printing process.

Although the component storage device 303 is illustrated as being integrated within the 3D printer 102, the component storage device 303 can instead be positioned externally to the 3D printer 102. As an example, the component storage device 303 is a tray that is external to the 3D printer 102. A human operator or machine, e.g., a robot, receives the component model identifier from the 3D printer 102, e.g., through a display on the 3D printer, or the computing device 103. In one implementation, the human operator or machine then retrieves the corresponding electronic component from the component storage device 303 and positions the electronic component in the 3D printer 102 for placement in the object 108 during the 3D printing process. In another implementation, the human operator or machine also receives positioning data from the 3D printer 102 or the computing device 103 so that the human operator or machine can place the electronic component in the object 108 during the 3D printing process.

If the 3D printer 102 prints electronic components rather than using prefabricated electronic components, the component storage device 303 can be used instead for the storage of materials for printing such electronic components. For instance, the component storage device 303 can store metal, conductors, plastics, etc. for printing electronic components that are integrated within the object 108 during the 3D printing process for the object 108.

The processor 301 also programs each component with code based upon an electronic effect file, e.g., an audio file, a video file, a haptic effect file, a lighting file, etc., that is used by the component to perform an electronic effect according to the programming. The code comprises instructions that the component uses to perform actions or refrain from actions using the programming data 112. For instance, the code can include instructions for an electronic component to play an audio file when a button is pressed. The processor 301 performs the programming prior to placement of the component within the object 108 during the 3D printing process. In one implementation, the processor 301 programs a component via a wireless instruction sent from the processor 301 through a transceiver 304 to the component. In another implementation, the processor 301 programs a component via a direct wired connection, e.g., through a cable. A component can also be programmed prior to the printing process, e.g., a non-printed component can be programmed during a manufacturing process with the programming data 112.

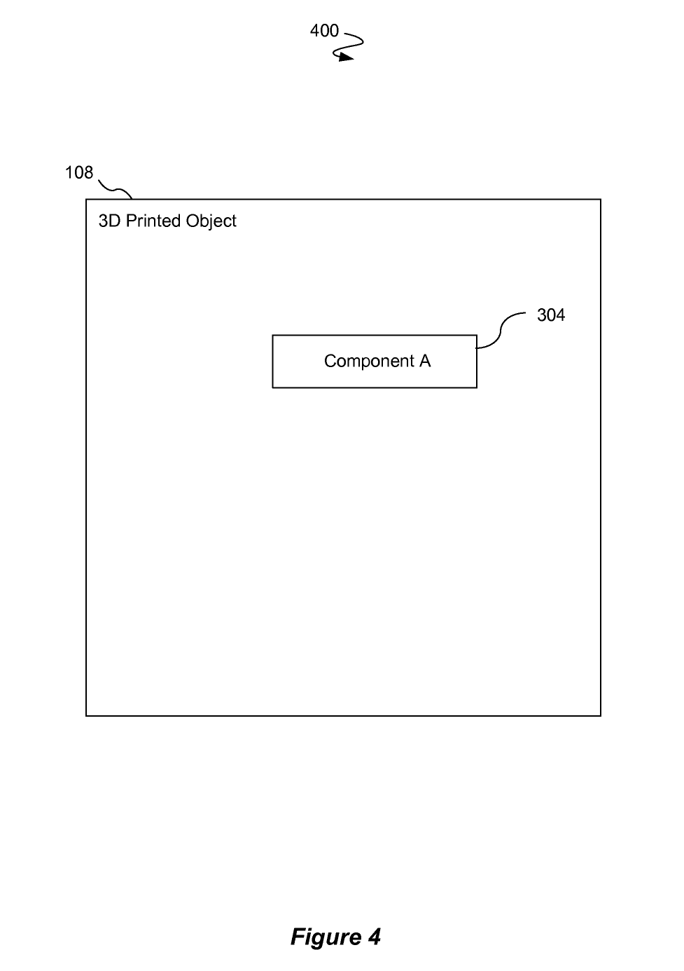

FIG. 4 illustrates an example of the object 108 that is printed with an integrated electronic component such as component A 304 illustrated in FIG. 3. Although a single electronic component is illustrated, the object 108 can have multiple integrated electronic components. Some of the integrated electronic components can be prefabricated whereas other of the integrated electronic components can be printed during the 3D printing process. As an example, the 3D printer 102 retrieves a prefabricated audio component that has a processor and a particular audio file with a voice recording of a movie character. The 3D printer 102 positions that prefabricated audio component in the object 108 during the 3D printing process. The 3D printer 102 also obtains data for 3D printing an audio speaker and corresponding electronic circuitry. The 3D printer 104 3D prints the audio speaker and corresponding electronic circuitry during the 3D printing process. The 3D printer 104 then positions the audio speaker and corresponding electronic circuitry in the object 108 during the 3D printing process.

The components 304, 305, 306, or 307 can also be programmed to send an Infrared (“IR”) communication or a Radio Frequency (“RF”) communication that activates another object to provide an electronic effect, etc. As an example of a communication that activates another object, multiple toys can be printed with electronic components that interact with each other. Upon the toys being positioned within a proximity to each other, an exchange of audio communications can occur between the two toys, e.g., the two toys emit programmed audio recordings that constitute a conversation, song, etc. The interactions between the toys are not limited to audio effects as other electronic effects can also be activated based upon IR or RF communications emitted when the toys are in proximity to each other, e.g., lighting effects, haptic effects, etc. Further, all of the toys that interact with each other do not have to have to be printed according to the 3D printing process. As an example, a toy that is printed according to the 3D printing process can activate a voice recording of a toy that is not printed according to the integration process or have a voice recording activated by that other toy through an IR or RF communication.

The process for integrating object geometry data of an object, data that describes an electronic component that is embeddable within the object, and/or programming data can be performed without the printer 104. The integration can be performed automatically by a computing device 103 and then may or may not be used by a printer 104 that is not associated with the computing device 103.

The processes described herein may be implemented in a general, multi-purpose or special purpose processor. Such a processor will execute instructions, either at the assembly, compiled or machine-level, to perform the processes. Those instructions can be written by one of ordinary skill in the art following the description herein and stored or transmitted on a computer readable medium. The instructions may also be created using source code or a computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer (“PC”), laptop, smartphone, tablet device, set top box, or the like.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

I claim:

1. A method comprising:
integrating object geometry data of an object and data that describes an electronic component that is embeddable within the object to generate an integrated 3D printable model; and
printing an integrated 3D printable object based upon the integrated 3D printable model.

2. The method of claim 1, further comprising:
partially printing the integrated 3D printable object;
retrieving the electronic component;
operably connecting the electronic component to the partially printed integrated 3D printable object; and
printing a remainder of the integrated 3D printable object.

3. The method of claim 1, further comprising integrating programming data with the object geometry data and the data that describes the electronic component to generate the integrated 3D printable model, the programming data being used by the electronic component to provide an electronic effect.

4. The method of claim 3, wherein the electronic effect is selected from the group consisting of: an audio playback, a haptic effect, a lighting feature, and an IR communication that activates another object to provide an electronic effect.

5. The method of claim 1, wherein the data that describes the electronic component further comprises electronic circuitry data, electronic component identifier data, and electronic component quantity data.

6. The method of claim 1, further comprising selecting the electronic component based upon specifications of the object.

7. The method of claim 1, further comprising receiving the object geometry data and the data that describes the electronic component from a server.

8. An apparatus comprising:
a processor that integrates object geometry data of an object and data that describes an electronic component that is embeddable within the object to generate an integrated 3D printable model; and
at least one 3D printer head that prints an integrated 3D printable object based upon the integrated 3D printable model.

9. The apparatus of claim 8, wherein the data that describes the electronic component comprises location data for placement of the electronic component within the 3D object.

10. The apparatus of claim 8, wherein the electronic component is programmed with programming data that is used to provide an electronic effect.

11. The apparatus of claim 10, wherein the electronic effect is selected from the group consisting of: an audio playback, a haptic effect, a lighting feature, and an IR communication that activates another object to provide an electronic effect.

12. The apparatus of claim 8, wherein a server receives the object geometry data and the data that describes the electronic component.

13. A system comprising:
a computing device that integrates object geometry data of an object and data that describes an electronic component that is embeddable within the object; and
a 3D printer that prints an integrated 3D printable object based upon the integrated 3D printable model

14. The system of claim 13, wherein the data that describes the electronic component comprises location data for placement of the electronic component within the 3D object.

15. The system of claim 13, wherein the electronic component is programmed with programming data that is used to provide an electronic effect.

16. The system of claim 15, wherein the electronic effect is selected from the group consisting of: an audio playback, a lighting feature, and an IR communication that activates another object to provide an electronic effect.

17. The system of claim 13, wherein the data that describes the electronic component further comprises electronic circuitry data, electronic component identifier data, and electronic component quantity data.

18. The system of claim 13, wherein the computing device selects the electronic component based upon specifications of the object.

19. The system of claim 13, further comprising a server that sends the object geometry data and the data that describes the electronic component to the computing device.

20. The system of claim 13, wherein the electronic component comprises a sensor and a processor, the sensor sensing external data and providing the external data to the processor, the processor activating the electronic effect based upon the external data.

21. A method comprising:
integrating object geometry data of an object and data that describes an electronic component that is embeddable within the object to generate an integrated 3D printable model.
